(19) United States
(12) Patent Application Publication
(10) Pub. No.: US 2025/0306986 A1
(43) Pub. Date: Oct. 2, 2025

(54) SHADER CORE INDEPENDENT SORTING CIRCUIT

(71) Applicant: ADVANCED MICRO DEVICES, INC., Santa Clara, CA (US)

(72) Inventors: Dominik Joerg Baumeister, Munich (DE); Fabian Robert Sebastian Wildgrube, Mönkeberg (DE); Matthaeus G. Chajdas, Munich (DE); Nicolai Haehnle, Munich (DE); Sebastian Josef Neubauer, Munich (DE)

(21) Appl. No.: 18/618,504

(22) Filed: Mar. 27, 2024

(51) Int. Cl. G06F 9/48; G06F 9/54

(52) U.S. Cl. CPC G06F 9/4881; G06F 9/542

(57) ABSTRACT

A processor includes a plurality of processing elements. Each processing element of the plurality of processing elements includes one or more compute units. The processor further includes a sorting circuit. The sorting circuit is configured to receive a request from a compute unit of the one or more compute units to export a payload. Responsive to receiving the request, the sorting circuit is configured to determine if a bucket for sorting the payload is available based on a first key included in the request. Responsive to a bucket being available, the sorting circuit is further configured to send a response to the compute unit including an indication of the bucket.

### BACKGROUND

Graphics processing applications often include work streams of vertices and texture information and instructions to process such information. The various items of work (also referred to as “commands”) may be prioritized according to some order and enqueued in a system memory buffer to be subsequently retrieved and processed. Scheduler circuits receive work to be executed and generate one or more commands to be scheduled and executed at, for example, processing resources of an accelerated processing device (APD), a graphics processing unit (GPU), or other single instruction-multiple data (SIMD) processing unit.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an example processing system in accordance with some implementations.

FIG. 2 is a block diagram of portions of a processor implementing hierarchical scheduler circuits in accordance with some implementations.

FIG. 3 is a block diagram illustrating one configuration of a processor implementing a compute unit-independent sorting circuit in accordance with some implementations.

FIG. 4 is a block diagram illustrating another configuration of a processor implementing a compute unit-independent sorting circuit in accordance with some implementations.

FIG. 5 is a block diagram illustrating a more detailed view of the compute unit-independent sorting circuit of FIG. 3 and FIG. 4 in accordance with some implementations.

FIG. 6 illustrates an example of a sorting data structure 514 implemented by the compute unit-independent sorting circuit of FIG. 3 and FIG. 4 in accordance with some implementations.

FIG. 7, FIG. 8, FIG. 9, and FIG. 10 together are a flow diagram illustrating an example method of a sorting circuit in a scheduling domain performing compute unit-independent sorting of payloads in accordance with at least some implementations.

### DETAILED DESCRIPTION

The performance of processing devices implementing GPU architectures and other parallel-processing architectures continues to increase as applications perform large numbers of operations involving many iterations (or timesteps) and multiple operations within each step. To reduce overhead and enhance performance, multiple work items are bundled and dispatched to the GPU in a single CPU operation, rather than launching each one separately. The dependencies and execution sequences of the work items can be effectively organized and visualized using work graph structures. Graph-based software architectures, often referred to as dataflow architectures, are common to software applications that process continual streams of data or events.

In the context of a work graph, a work item is an undefined portion of work that is to be performed as part of executing a node on, for example, a shader core. Each node in a work graph represents or defines, for example, the shader that is being executed once the input constraints of the node are fulfilled. Each edge (or link) between two nodes corresponds to a dependency (such as a data dependency, an execution dependency, or some other dependency) between the two linked nodes. When a node is launched, a compute unit, such as a shader core, executes a program (e.g., a shader) and generates a payload, which holds the actual data being transported along the edges of the work graph. These new payloads are then stored and scheduled for execution by another (or the same) compute unit. However, conventional techniques for storing and scheduling these new payloads can incur significant memory overhead, execution overhead, and scheduling latency.

For example, some conventional systems typically configure multiple different nodes of a work graph to write their payloads to a specified chunk of memory, which is a contiguous region of memory. In many instances, this memory chunk has multiple different types of payloads from multiple different nodes. Therefore, when the memory chunk is full, another compute unit (herein referred to as a “sorting unit”) is scheduled to sort all of the different payloads in the memory chunk. As part of the sorting operation, the sorting unit identifies all of the payloads associated with the same node and groups these payloads together in the memory chunk. After the sorting operation has been performed, the sorting unit notifies a scheduler, which proceeds to schedule the sorted payloads for dispatching to their associated nodes. All of the different memory accesses involved in writing the payloads to memory and then sorting the payloads are computationally expensive and potentially increase the scheduling times associated with the payloads.

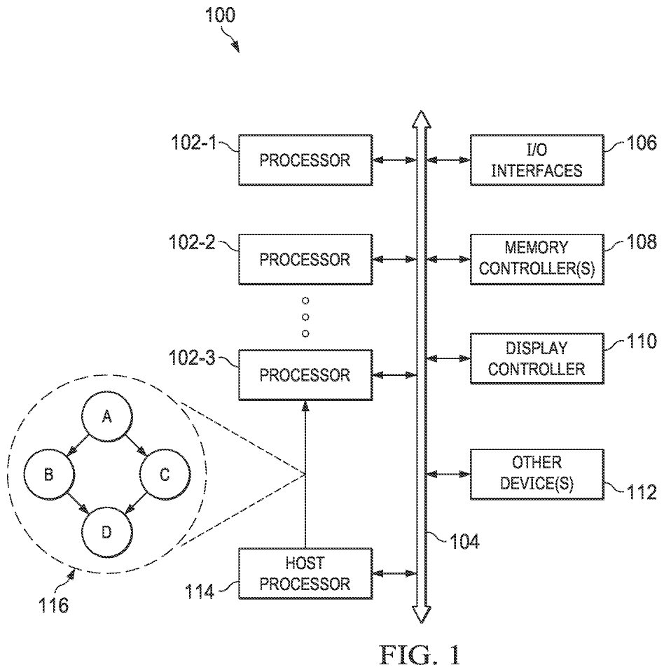

To address these problems and to enable improved coherency and scheduling of complex graphs and other executable items, FIG. 1 to FIG. 10 describe systems and methods for payload sorting that include one or more sorting circuits sorting payloads independent of the compute units that generated the payloads. As described below, one or more sorting circuits are implemented within a processor, such as an accelerated processor or a parallel processor. For example, one or more sorting circuits are implemented within the scheduling domains of the processor. If a scheduling domain includes a local scheduler circuit, such as a work graph scheduler (WGS), a sorting circuit, in at least some implementations, is implemented per WGS. In other implementations, a sorting circuit is implemented per processing unit within the scheduling domains of the processor.

Payloads produced by compute units are exported into the sorting circuit. The sorting circuit sorts the payloads into buckets of likewise keys. In at least some implementations, each bucket is backed by a virtual memory address pointing to a software-provided page of memory of a specified (but sufficient) size to hold all payloads for a single thread group launch. When a bucket is full, the sorting circuit interfaces with one or more schedulers in the scheduling domain to launch filled buckets. The scheduler(s) then schedules the payload for execution by one or more other compute units. As such, the sorting circuit improves coherency recovery time by sorting payloads to be consumed by the same consumer compute unit(s) into the same bucket(s). The producer compute units are able to perform processing while the sorting operations are being performed by the sorting circuit in parallel. Also, having the sorting circuit perform the sorting operations allows a wave to exit while the sorting circuit is accumulating payloads from other compute units. Stated differently, because a compute unit associated with the wave does not transfer ownership of its own resources, such as registers, to the sorting circuit, the wave does not need to stay alive during the sorting process. Also, filled buckets can be immediately launched by the sorting circuit through, for example, local schedulers of the scheduling domain, or evicted by the sorting circuit upon receiving an external request from, for example, a compute unit or a local scheduler. These aspects of the sorting circuit fully decouple any producer compute unit from potential consumer compute units and other producer compute unites. It should be understood that in addition to work graph payloads, the sorting/coalescing techniques described herein are applicable to other operations, such as raytracing or hit shading, and other objects, such as rays and material identifiers (IDs).

FIG. 1 illustrates a block diagram of a computing system 100 employing compute unit independent sorting for hierarchical work scheduling in accordance with at least some implementations. The computing system 100, in at least some implementations, includes at least one or more processors 102 (illustrated as processors 102-1 to 102-3), a fabric 104, input/output (I/O) interfaces 106, a memory controller(s) 108, a display controller 110, and other devices 112. In at least some implementations, to support execution of instructions for graphics and other types of workloads, the computing system 100 also includes a host processor 114, such as a central processing unit (CPU). The computing system 100, in at least some implementations, is a computer, laptop, mobile device, server, or any of various other types of computing systems or devices. It is noted that the number of components of the computing system 100 may vary. It is also noted that in implementations computing system 100 includes other components not shown in FIG. 1, and the computing system 100, in at least some implementations, is structured differently than shown in FIG. 1.

The fabric 104 is representative of any communication interconnect that complies with any of various types of protocols utilized for communicating among the components of the computing system 100. The fabric 104 provides the data paths, switches, routers, and other logic that connect the processors 102, I/O interfaces 106, memory controller(s) 108, display controller 110, and other devices 112 to each other. The fabric 104 handles the request, response, and data traffic, as well as probe traffic to facilitate coherency. Interrupt request routing and configuration of access paths to the various components of the computing system 100 are also handled by the fabric 104. Additionally, the fabric 104 handles configuration requests, responses, and configuration data traffic. In at least some implementations, the fabric 104 is bus-based, including shared bus configurations, crossbar configurations, and hierarchical buses with bridges. In other implementations, the fabric 104 is packet-based, and hierarchical with bridges, crossbar, point-to-point, or other interconnects. From the point of view of the fabric 104, the other components of computing system 100 are referred to as “clients”. The Fabric 104 is configured to process requests generated by various clients and pass the requests on to other clients.

The memory controller(s) 108 is representative of any number and type of memory controller coupled to any number and type of memory device(s). For example, the types of memory device(s) coupled to the memory controller(s) 108 include Dynamic Random Access Memory (DRAM), Static Random Access Memory (SRAM), NAND Flash memory, NOR (Not Or) flash memory, Ferroelectric Random Access Memory (FeRAM), or others. The memory controller(s) 108 is accessible by the processors 102, I/O interfaces 106, display controller 110, and other devices 112 via the fabric 104. The I/O interfaces 106 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices are coupled to the I/O interfaces 106. Such peripheral devices include (but are not limited to) displays, keyboards, mice, printers, scanners, joysticks or other types of game controllers, media recording devices, external storage devices, network interface cards, and so forth. The other device(s) 112 are representative of any number and type of devices (e.g., multimedia device, video codec, or the like).

In at least some implementations, one or more of the processors 102 are a parallel processor (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, digital signal processors (DSPs), field programmable gate arrays (FPGAs), application specific integrated circuits (ASICs), and the like. Each parallel processor 102, in at least some implementations, is constructed as a multi-chip module (e.g., a semiconductor die package) including two or more base integrated circuit (IC) dies communicably coupled together with bridge chip(s) or other coupling circuits or connectors such that a parallel processor is usable (e.g., addressable) like a single semiconductor integrated circuit. As used in this disclosure, the terms “die” and “chip” are interchangeably used. Those skilled in the art will recognize that a conventional (e.g., not multi-chip) semiconductor integrated circuit is manufactured as a wafer or as a die (e.g., single-chip IC) formed in a wafer and later separated from the wafer (e.g., when the wafer is diced); multiple ICs are often manufactured in a wafer simultaneously. The ICs and possibly discrete circuits and possibly other components (such as non-semiconductor packaging substrates including printed circuit boards, interposers, and possibly others) are assembled in a multi-die parallel processor.

One or more other processors 102, in at least some implementations, are an accelerated processor that combines, for example, a general-purpose CPU and a GPU. The AP accepts both compute commands and graphics rendering commands from the host processor 114 or another processor 102. The AP includes any cooperating collection of hardware, software, or a combination thereof that performs functions and computations associated with accelerating graphics processing tasks, data-parallel tasks, nested data-parallel tasks in an accelerated manner with respect to resources such as conventional CPUs, conventional GPUs, and combinations thereof. The AP and the host processor 114, in at least some implementations, are formed and combined on a single silicon die or package to provide a unified programming and execution environment. In other implementations, the AP and the host processor 114 are formed separately and mounted on the same or different substrates.

Each of the individual processors 102, in at least some implementations, includes one or more base IC dies employing processing chiplets. The base dies are formed as a single semiconductor chip including N number of communicably coupled graphics processing stacked die chiplets. In at least some implementations, the base IC dies include two or more direct memory access (DMA) engines that coordinate DMA transfers of data between devices and memory (or between different locations in memory).

In at least some implementations, parallel processors, accelerated processors, and other multithreaded processors 102 implement multiple processing elements (not shown) (also referred to herein as “processor cores” or “compute units”) that are configured to execute concurrently or in parallel multiple instances (threads or waves) of a single program on multiple data sets. Several waves are created (or spawned) and then dispatched to each processing element in a multi-threaded processor. In implementations, a processing unit includes hundreds of processing elements so that thousands of waves are concurrently executing programs in the processor. The processing elements in a GPU typically process three-dimensional (3-D) graphics using a graphics pipeline formed of a sequence of programmable shaders and fixed-function hardware blocks.

The host processor 114 prepares and distributes one or more operations to the one or more processors 102 (or other computing resources), and then retrieves results of one or more operations from the one or more processors 102. The host processor 114, in at least some implementations, sends work to be performed by the one or more processors 102 by queuing various work items (also referred to as “threads”) in a command buffer (not shown). A stream of commands, in at least some implementations, is recorded on the host processor 114 to be processed on a processor 102, such as a GPU or accelerated processor. Examples of a command include a kernel launch during which a program on a number of hardware threads is executed, or other hardware-accelerated operations, such as direct memory accesses, synchronization operations, cache operations, or the like. The processor 102 consumes these commands one after the other.

In at least some implementations, one or more of the processors 102 or host processor 114 execute at least one work graph. A work graph adds another command executable by a processor 102 that launches an entire graph including multiple kernel launches depending on the data flowing through the graph (e.g., payloads). In particular, a workload including multiple work items is organized as a work graph (or simply “graph”), where each node in the graph represents the program, such as a shader, being executed once the input constraints of the node are fulfilled and each edge (or link) between two nodes corresponds to a dependency (such as a data dependency, an execution dependency, or some other dependency) between the two nodes. To illustrate, the work graph 116 includes shaders forming the nodes (A to D of the work graph 116, with the edges being the dependencies between shaders. In at least one implementation, a dependency indicates when the work of one node has to complete before the work of another node can begin. In at least some implementations, a dependency indicates when one node needs to wait for data (e.g., a payload) from another node before it can begin and/or continue its work. One or more processors 102, in at least some implementations, execute the work graph 116 after invocation by the host processor 114 by executing work starting at node A. As shown, the edges between node A and nodes B and C (as indicated by the arrows) indicate that the work of node A has to be completed before the work of nodes B and C can begin. In at least some implementations, the work performed at the nodes of work graph 116 includes kernel launches, memory copies, CPU function calls, or other work graphs (e.g., each of nodes A to D may correspond to a sub-graph (not shown) including two or more other nodes).

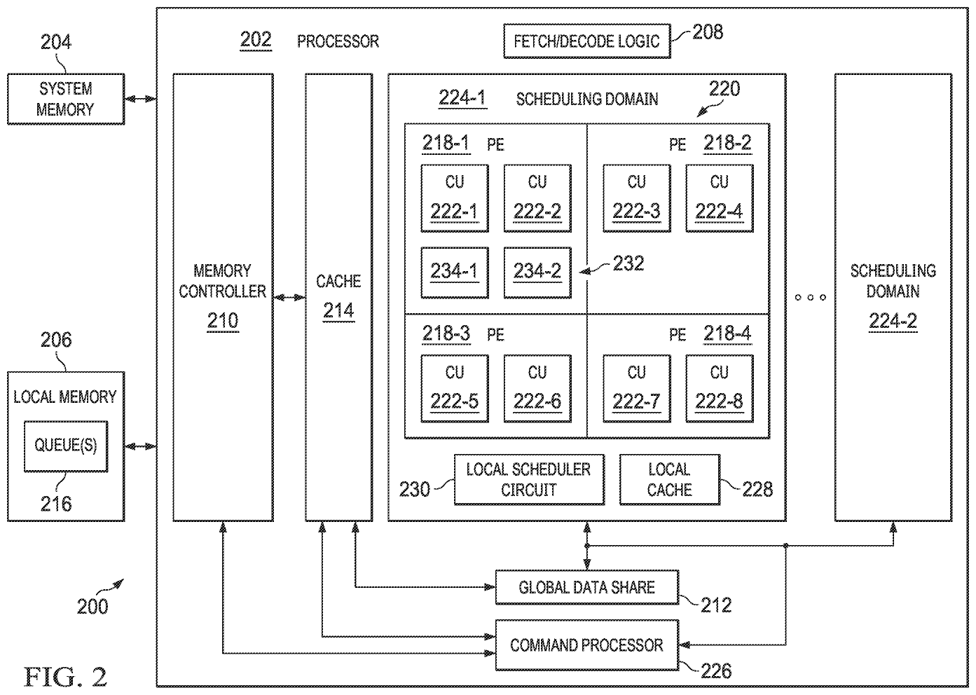

Referring now to FIG. 2, a more detailed block diagram of a computing system 200, such as the computing system 100 of FIG. 1, is shown. In at least some implementations, the computing system 200 includes one or more processors 202, such as the processors 102 of FIG. 1, system memory 204, and local memory 206 belonging to the processor 202, fetch/decode logic 208, a memory controller 210, a global data store 212 (e.g., a shared cache), and one or more levels of cache 214. The computing system 200 also includes other components that are not shown in FIG. 1 for brevity.

In at least some implementations, the local memory 206 includes one or more queues 216. In other implementations, the queues 216 are stored in other locations within the computing system 200. The queues 216 are representative of any number and type of queues that are allocated in computing system 200. In at least some implementations, the queues 216 store rendering or other tasks to be performed by the processor 202. The fetch/decode logic 208 fetches and decodes instructions in the waves of the workgroups that are scheduled for execution by the processor 202. Implementations of the processor 202 execute waves in a workgroup. For example, in at least some implementations, the fetch/decode logic 208 fetches kernels of instructions that are executed by all the waves in the workgroup. The fetch/decode logic 208 then decodes the instructions in the kernel. The global data store 212 and cache 214, respectively, store shared and local copies of data and instructions that are used during execution of the waves.

The processor 202, in at least some implementations, includes one or more processing elements (PEs) 218 (illustrated as processing elements 218-1 to 218-4). One example of a processing element 218 is a workgroup processor (WGP) also referred to herein as a “workgroup processing element”. In at least some implementations, a WGP is part of a shader engine 220 of the processor 202. Each of the processing elements 218 includes one or more compute units (CUs) 222 (illustrated as compute unit 222-1 to 222-8), such as one or more stream processors (also referred to as arithmetic-logic units (ALUs) or shader cores), one or more single-instruction multiple-data (SIMD) units, one or more logical units, one or more scalar floating point units, one or more vector floating point units, one or more special-purpose processing units (e.g., inverse-square root units, since/cosine units, or the like), a combination thereof, or the like. Stream processors are the individual processing elements that execute shader or compute operations. Multiple stream processors are grouped together to form a compute unit or a SIMD unit. SIMD units, in at least some implementations, are each configured to execute a thread concurrently with execution of other threads in a wavefront (e.g., a collection of threads that are executed in parallel) by other SIMD units, e.g., according to a SIMD execution model. The SIMD execution model is one in which multiple processing elements share a single program control flow unit and program counter and thus execute the same program but are able to execute that program with different data. The number of processing elements 218 implemented in the processor 202 is configurable.

Each of the one or more processing elements 218 executes a respective instantiation of a particular work item to process incoming data, where the basic element of execution in the one or more processing elements 218 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a processing element 218.

In at least some implementations, the processor 202 includes one or more scheduling domains 224 (illustrated as scheduling domain 224-1 and scheduling domain 224-1). A scheduling domain 224 is also referred to herein as a “node processor 224” due to its processing of work at the nodes of a work graph, such as work graph 116 as previously described. In at least some implementations, a scheduling domain 224 is comprised of or is defined by a shader engine 220 which, as described above, includes one or more compute units 222 each including at least one stream processor or shader processor, one or more rasterizers, one or more graphics pipelines, one or more computer pipelines, a combination thereof, or the like. In at least some implementations, the scheduling domains 224 execute work received from a global command processor (CP) 226 (also referred to herein as a “global scheduler circuit 226”) that communicates with all of the scheduling domains 224. Each scheduling domain (e.g., shader engines 220), in at least some implementations includes a local cache 228 and also has access to the global data share (e.g., global cache) 212.

Each scheduling domain 224, in at least some implementations, includes a local scheduler circuit 230 (also referred to herein as a “work graph scheduler circuit (WGS) 230” associated with a set of processing elements 218 (e.g., WGPs). In at least some implementations, the various scheduler circuits and command processors described herein handle queue-level allocations. During execution of work, the local scheduler circuit 230 executes work locally in an independent manner. In other words, the local scheduler circuit 230 of a scheduling domain 224 is able to schedule work without regard to local scheduling decisions of other scheduling domains 224 (e.g., shader engines 220). Stated differently, the local scheduler circuit 230 does not interact with other local scheduler circuits 230 of other scheduling domains 224. Instead, the local scheduler circuit 230 uses a private memory region for scheduling and as scratch space. The compute units 222 of a processing element 218 execute the work items scheduled by the local scheduler circuit 230 of their scheduling domain 224.

The execution of work items by compute units 222, such as shader cores, of a processing element 218, such as a WGP, often produces payloads for consumption (i.e., execution) by one or more other compute units 222 within the same or different scheduling domain 224. For example, FIG. 1 shows that a first compute unit 222-1 generated a payload 232 including data 234 (illustrated as data 234-1 and data 234-2). The payload 232, in at least some implementations, is to be executed by one or more other processing elements 218, such as processing elements 218-2, in the same scheduling domain 224-1 as the first compute unit 218-1 or by another processing elements 218 in a different scheduling domain 224-2. In terms of a work graph, a node (e.g., a shader) in the graph generates a payload 232 that is to be executed by another node (e.g., compute unit) in the graph.

Conventionally, compute units are typically configured to write their payloads to a contiguous region of memory referred to as a memory chunk. In many instances, this memory chunk has multiple different types of payloads from multiple different nodes. Therefore, when the memory chunk is full, another computing unit is configured to sort all of the different payloads in the memory chunk. As part of the sorting operation, the sorting compute unit identifies all of the payloads that are to be executed by the same compute unit and groups these payloads together in the memory chunk. After the sorting operation has been performed, the sorting compute unit notifies a scheduler, such as a command processor or local scheduler, which proceeds to schedule the sorted work items for dispatching to their associated compute units. All of the different memory accesses involved in writing the work items to memory and then sorting the work items are computationally expensive and potentially increase the scheduling times associated with the work items.

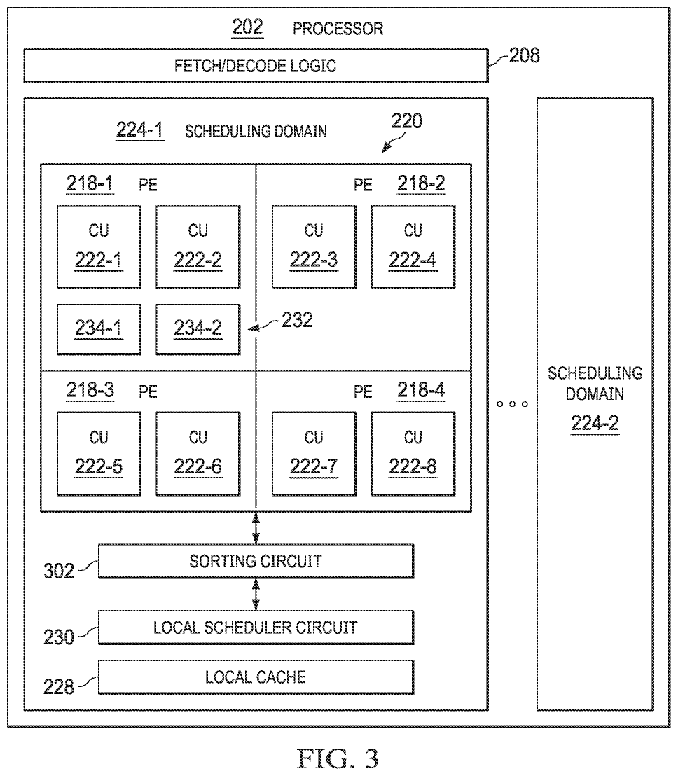

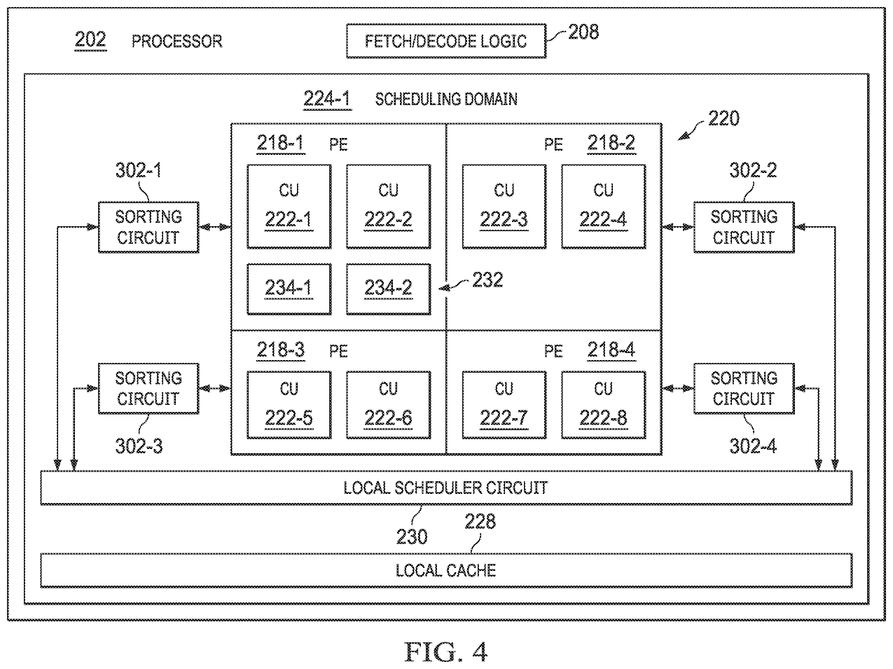

As such, as shown in FIG. 3, one or more sorting circuits 302 are implemented within the processor 202 that performs sorting or coalescing operations on payloads 232 independent of the compute unit 222 that generated the payloads 232. In at least some implementations, one or more sorting circuits 302 are implemented within the scheduling domains 224 of the processor 202. For example, in at least some embodiments, a sorting circuit 302 is implemented per local scheduler circuit 230 within one or more scheduling domains 224. In other implementations, a sorting circuit 302 (illustrated as sorting circuit 302-1 to sorting circuit 302-4) is implemented per processing element 218 within one or more scheduling domains 224 of the processor, as shown in FIG. 4.

In at least some implementations, payloads 232 produced by compute units 222 are exported into the sorting circuit 302. As described in greater detail below, the sorting circuit 302 sorts payloads 232 into buckets of likewise keys. In at least some implementations, each bucket is backed by a virtual memory address pointing to a software-provided page of memory of a specified (but sufficient) size to hold all payloads 232 for a single thread group launch. When a bucket is full, the sorting circuit 302 interfaces with one or more local scheduler circuits 230 in the scheduling domain 224 to launch filled buckets. The local scheduler circuit(s) 230 then schedules the payloads 232 for execution by one or more other compute units 222. As such, the sorting circuit 302 reduces coherency recovery time by sorting payloads 232 to be consumed by the same consumer compute unit(s) 222 into the same bucket(s). The producer compute units 222 are able to perform processing while the sorting operations are being performed by the sorting circuit 302 in parallel. Also, having the sorting circuit 302 perform the sorting operations allows a wave to exit while the sorting circuit 302 is accumulating payloads from other compute units 22. Filled buckets can be immediately launched by the sorting circuit 302 through, for example, the local scheduler circuit(s) 230 of the scheduling domain 224, or evicted by the sorting circuit 302 upon receiving an external request from, for example, a compute unit 222 or a local scheduler circuit 230. These aspects of the sorting circuit 302 fully decouple any producing compute unit 222 from potential consumer compute units 222.

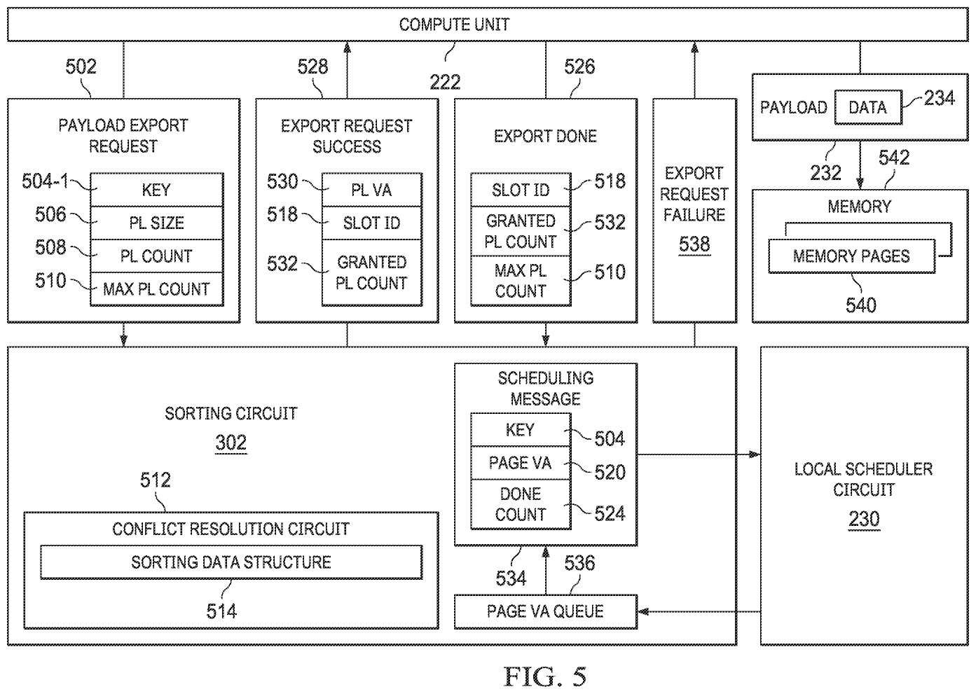

For example, referring now to FIG. 5, when a producer compute unit 222, such as a shader core, within a scheduling domain 224 generates a payload 232, the producer compute unit 222 submits a payload export request 502 to the sorting circuit 302. The payload export request 502, in at least some implementations, includes parameters such as a key 504 (illustrated as key 504-1-1), payload (PL) size 506, a payload count 508, and a maximum payload count 510. The key 504-1, in at least some implementations, is set to the unique identifier (ID) of a consumer compute unit 222 intended to execute the payload 232. The payload count 508 indicates the number of payloads 232 awaiting to be exported by the producer compute unit 222, and the maximum payload count 510 indicates the number of payloads 232 that can occupy a memory page 540 (also referred to herein as a “bucket 540”) in memory 542, such as local memory 206, before the memory page 540 is to be evicted from the sorting circuit 302 (e.g., no longer in use by the sorting circuit 302).

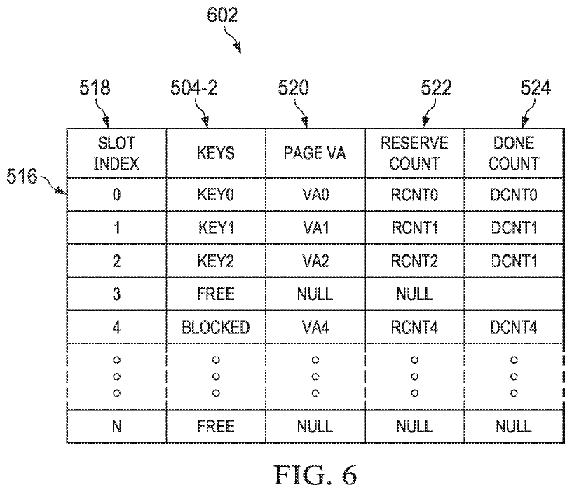

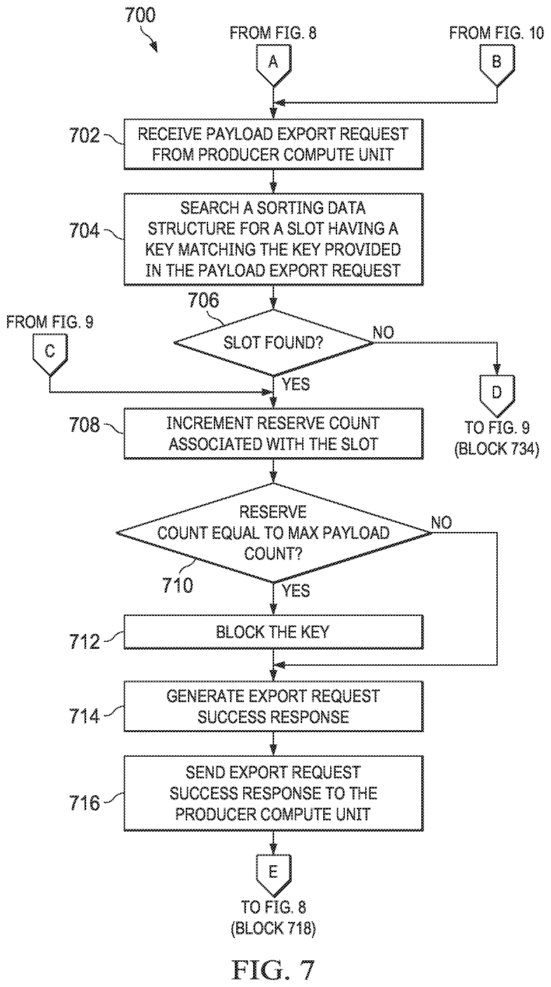

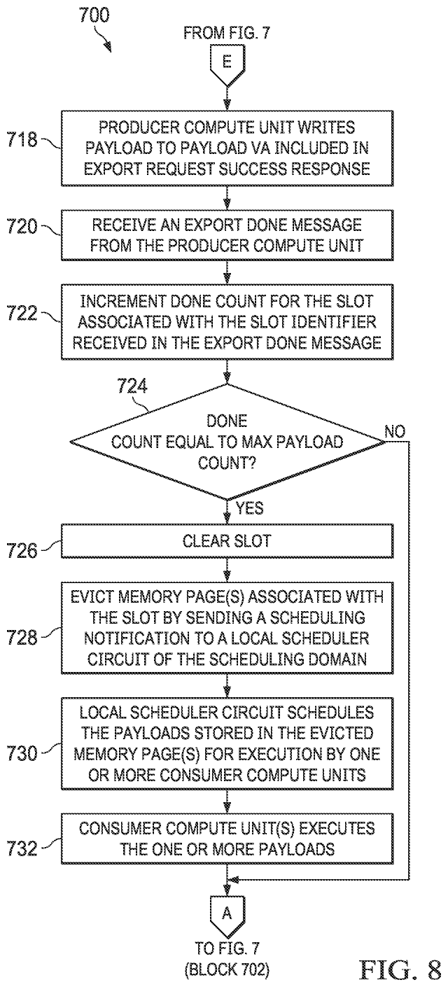

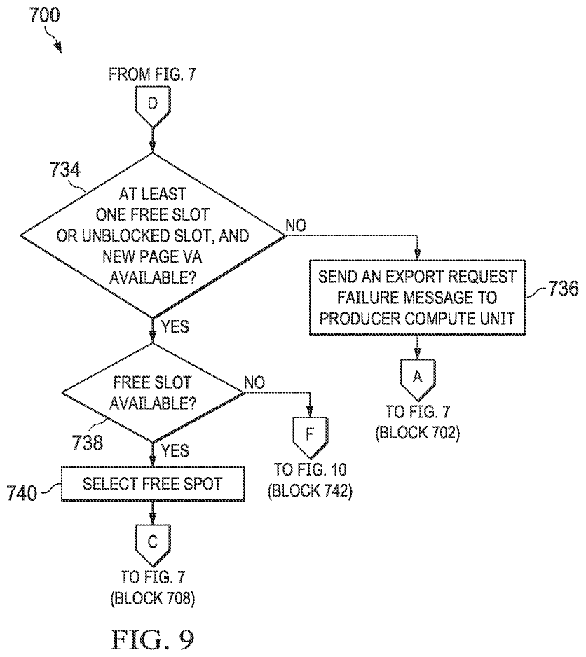

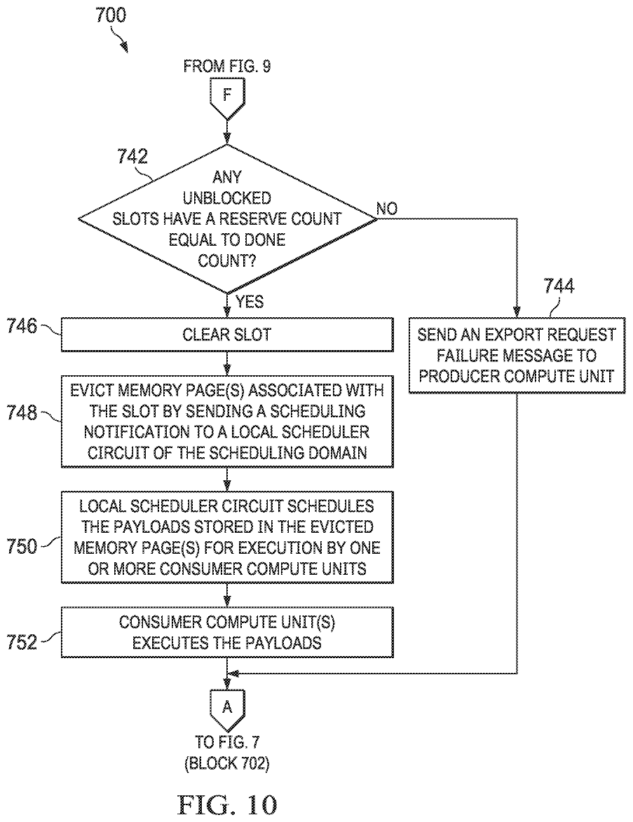

The sorting circuit 302, in at least some implementations, implements a conflict resolution circuit 512 that performs any changes (as described below with respect to FIG. 7 to FIG. 10) to an underlying sorting data structure 514, such as a table, used for conflict resolution such that the associated operations appear as atomic operations. FIG. 6 shows one example of the sorting data structure 514. It should be understood that other configurations of the sorting data structure 514 are applicable as well. In the example shown in FIG. 6, the sorting data structure 51 maps key-slot pairs to a plurality of memory pages (buckets) 540. For example, each entry 516 (also referred to herein as “slot 516”) in the sorting data structure 514, includes, for example, a slot identifier/index 518, a key 504 (illustrated as key 504-2), a page virtual address (VA) 520, a reserve count 522, and a done count 524. The slot identifier 518 (e.g., a slot number) acts as an index into the sorting data structure 514. The key 504, in at least some implementations, is a unique identifier associated with the payload 232 stored within the memory page 540 mapped to the identified slot 516. Stated differently, the key 504 is a unique identifier associated with likewise payloads 232 to be grouped together. The page virtual address 504-2 is the virtual address associated with the memory page 540 being used to bucket payloads 232 associated with the slot 516 and key 504-2. In at least some implementations, the memory pages 540 and their virtual addresses 520 are allocated to the sorting circuit 302 by the local scheduler circuit 230. The sorting circuit 302 determines available memory pages 540 and their associated virtual addresses 520 from a data structure, such as a page virtual address queue 536, populated by, for example, the local scheduler circuit 230. The reserve count 522 indicates the current number of payload export requests 502 received for the specified slot 516 and key 504-2. The done count 524 tracks the number of export done messages 526 received from a producing compute unit 222. However, in at least some implementations, multiple payloads 232 are exported per payload export request 502. In these implementations, the done count 524 tracks the number of payloads 232 exported instead of the number of export done messages 526 received from a producing compute unit 222. The export done message 526 signals the sorting circuit 302 that the producer compute unit 222 has completed its export process such that all payloads 232 have been written to the memory page 540 associated with the specified slot 516.

Returning to FIG. 5, in response to receiving a payload export request 502 from a compute unit 222, the sorting circuit 302 searches the sorting data structure 514 to determine if there is a slot 516 with a key 504-2 matching the key 504-1-1 provided in the payload export request 502. In the example illustrated in FIG. 5, the payload export request 502 received from the compute unit 222 includes the key 504-1, Key1. Therefore, in this example, the sorting circuit 302 searches the sorting data structure 514 for a slot 516 having a key 504-2, Key1. If the sorting circuit 302 finds a matching key 504-2, the sorting circuit 302 sends an export request success response 528 to the producer consumer unit 222 using one or more notification mechanisms, such as setting status flags or registers accessible by the producer consumer unit 222, generating one or more interrupts or signals, a combination thereof, or the like. As such, the keys 504 are used by the sorting circuit 302 to sort payloads 232 into buckets of likewise keys 504. In at least some implementations, rather than the slots 516 in the sorting data structure 514 being associated with keys 504, each slot 516 is associated with a specified compute unit identifier. In these implementations, when the sorting circuit 302 receives a payload export request 502 from a producer compute unit 222, the identifies the slot 516 associated with a consumer compute unit 222 based on an identifier of the consumer compute unit 222 included in the payload export request 502.

In at least some implementations, the response 528 includes an indication of the memory page (bucket) 540. For example, the response 528 includes a virtual address 530 (also referred to herein as a “payload virtual address 530”) associated with a location in memory 542, such as the memory page 540, where the producer compute unit 222 is able to store its payloads 232. In at least some implementations, the response 528 also includes the slot identifier 518 and granted payload count 532, which indicates the number of payloads 232 that can be written to the payload virtual address 530. The payload virtual address 530, in at least some implementations, is determined multiplying the payload size 506 indicated in the payload export request 502 by the reserve count 522 associated with the identified slot 516, and then adding this result to the virtual address 520 associated with the identified slot 516. The sorting circuit 302, in at least some implementations, also increments the reserve count 522 associated with the slot 516 based on the payload count 508 received in the payload export request 502. If the reserve count 522 equals the maximum payload count 510 set for the memory page(s) 540 associated with the identified slot 516, this indicates the memory page(s) 540 is full (or will be full) and the sorting circuit 302 blocks the key 504 associated with the slot 516 so that other compute units 222 are not able to write to the memory page(s) 540. Stated differently, this key 504 becomes unavailable and the sorting circuit 302 does not accept additional payloads 232 for this key 504 at the identified slot 516. However, in some instances, the sorting circuit 302 is able to accept additional payloads 232 for this key 504 at one or more different slots 516.

In response to receiving the response 528 from the sorting circuit 302, the producer compute unit 222 proceeds to write its payloads 232 to the payload virtual address 530 received from the sorting circuit 302. As such, the response 528 prompts the producer compute unit 222 to write its payload(s) 232 to the memory page 540. In at least some implementations, if the sorting circuit 302 returned a granted payload count 532 that is less than the export payload count 508 requested by the compute unit 22, the compute unit 222 resends the payload export request 502 with the same key 504-1. By resending the payload export request 502, a different slot 516 may be identified by the sorting circuit 302 such that a larger granted payload count 532 can potentially be provided to the producer compute unit 222. Otherwise, the producer compute unit 222 performs one or more fallback procedures, such as enqueuing the payload 232 into an overload buffer. In at least some implementations, the local scheduler circuit 230 schedules a compute unit 222 to read payloads 232 from the overflow buffer and send these payloads 232 to the sorting circuit 302 for sorting.

When the producer compute unit 222 has written all of its payloads 232 (or the maximum number of payloads 232 as indicated by the granted payload count 532) to the payload virtual address 530, the producer compute unit 222 sends an export done message 526 (or notification) to the sorting circuit 302. In at least some implementations, the producer compute unit 222 sends the export done message 526 using one or more notification mechanisms, such as setting status flags or registers accessible by the sorting circuit 302, generating one or more interrupts or signals, a combination thereof, or the like. The export done message 526 signals the sorting circuit 302 that the producer compute unit 222 has finished writing its payloads 232 to the payload virtual address 530. In at least some implementations, the export done message 526 includes one or more of the slot identifier 518, the granted payload count 532, and the maximum payload count 510.

Upon receiving the export done message 526, the sorting circuit 302 increments the done count 524 for the slot 516 associated with the slot identifier 518 received in the export done message 526. The sorting circuit 302 checks if the done count 524 for the slot 516 is equal to the maximum payload count 510. If the sorting circuit 302 determines that the done count 524 is not equal to the maximum payload count 510, the sorting circuit 302 determines that additional payloads 232 associated with the same key 504 can be written to the memory page 540 associated with the slot 516, and the sorting circuit 302 does not evict the memory page 540. However, if the done count 524 is equal to the maximum payload count 510, the sorting circuit 302 determines that no additional payloads 232 can be written to the memory page 540 for the slot 516. In these instances, the sorting circuit 302 clears/frees the slot 516 associated with the slot identifier 518 for reuse by, for example, changing a bit associated with the slot 516. In at least some implementations, the page virtual address 520 associated with the slot is set to null and the reserve count 522 and done count 524 for slot 516 are reset.

In addition to clearing the slot 516, the sorting circuit 302 also evicts the memory page 540 associated with the slot 516 from the sorting circuit 302. For example, the sorting circuit 302 sends a scheduling message 534 (or notification) to one or more scheduling mechanisms of the scheduling domain 224 by, for example, adding entries into a hardware-assisted queue, setting status flags or registers accessible by the scheduling mechanism(s), generating one or more interrupts or signals, a combination thereof, or the like. The scheduling message 534, in at least some implementations, is a tuple including the key 504 associated with the memory page 540 having the payloads 232 to be scheduled, the virtual address 520 of the memory page 540, and the done count 524 associated with the memory page 540. For example, the sorting circuit 302 sends the scheduling message 534 to the local scheduler circuit 230 of the scheduling domain 224, a local scheduler circuit 230 coupled to one or more individual processing elements 218 or compute units 222, or the like. The scheduling message 534 notifies the scheduling mechanism(s) that payloads 232 stored in the memory page 540 associated with the slot 516 are ready to be scheduled. In at least some implementations, when the scheduling mechanism receives the scheduling message 534, the scheduling mechanism proceeds to schedule the payloads 232 from the evicted memory page for execution by one or more of the consumer compute units 222 (or nodes in a work graph). Because the payloads 232 have already been sorted by the sorting circuit they are grouped together in memory 542, which improves coherency recovery time when the scheduling mechanism performs the scheduling operations. As such, sending the scheduling message 534 to the scheduling domain 224 enables the scheduling domain 224 to deduce how many payloads 232 to expect on a memory page 540, starting at the given virtual address 520. Together with the payload identifier, the scheduling domain 224 is able to identify the consumer compute unit 222, which in turn calculates the strides to read the payloads 232 from the memory page 540.

In an example, the local scheduler circuit 230 schedules one or more of the payloads 232 associated with the evicted memory page 540 for execution by at least one of the processing elements 218 in the scheduling domain 224. In at least some implementations, the one or more payloads 232 are launched by an asynchronous dispatch controller (not shown) of the scheduling domain 224 as wave groups via the local cache 228. The asynchronous dispatch controller, being located directly within the scheduling domain 224, builds the wave groups to be launched to the one or more processing elements 218. In at least some implementations, the local scheduler circuit 230 schedules the payloads 232 to be launched to the one or more processing elements 218 and then communicates a work schedule directly to the asynchronous dispatch controller using local atomic operations (or “functions”), direct register accesses, messages sent on a data bus, a combination thereof, or the like. In at least some implementations, the scheduled payloads 232 are stored in one or more local work queues (not shown) stored at the local cache 228. Further, the asynchronous dispatch controller builds wave groups including the scheduled payloads 232 stored at the one or more local work queues, and then launches the scheduled payloads 232 as wave groups to the one or more processing elements 218. In at least some implementations, the local scheduler circuit 230 distributes one or more of the payloads 232 from the evicted memory page 540 to another local scheduler circuit 230 in the same scheduling domain 224 or another scheduling domain 224. In addition to scheduling the payloads 232, the local scheduler circuit 230, in at least some implementations, adds the page virtual address 520 back to the queue 536 for reuse by the sorting circuit 302.

As described above, when the sorting circuit 302 receives a payload export request 502 from a producer compute unit 222, the sorting circuit 302 searches the sorting data structure 514 to determine if there is a slot 516 with a key 504-2 matching the key 504-1 provided in the payload export request 502. If the sorting circuit 302 finds a matching key 504-2, the sorting circuit 302 sends an export request success response 528 to the producer compute unit 222. However, in some instances, the sorting circuit 302 does not find a slot 516 with a matching key 504-2. For example, if the payload export request 502 includes the key 504-1, Key3, the sorting circuit 302 does not find a slot 516 with a matching key 504-2 in the example illustrated in FIG. 5. A matching key 504-2 may not be available in the sorting data structure 514 because the key 504-1 provided in the payload export request 502 has been blocked by the sorting circuit 302 as a result of the memory page(s) 540 associated with that key 504-1 being full, or a slot has not yet been configured with that key 504-1.

When the sorting circuit 302 does not find a slot 516 with a matching key 504-2 in the sorting data structure 514, the sorting circuit 302, in at least some implementations, determines if there are any free slots 516 or unblocked slots 516 in the sorting data structure 514. A free slot 516, in at least some implementations is a slot 516 that is unmapped to a memory page (bucket) 540, that is, the slot 516 is not associated with a key 504 that is mapped to a memory page 540. If all slots 516 are currently in use (e.g., associated with a memory page 540) or if all slots 516 are blocked, the sorting circuit 302 sends an export request failure response 538 to the producer compute unit 222 using one or more notification mechanisms, such as setting status flags or registers accessible by the consumer compute unit 222, generating one or more interrupts or signals, a combination thereof, or the like. The producer compute unit 222 then performs one or more fallback procedures, as described above.

If there is at least one free slot 516 in the sorting data structure 514, such as the slot 516 in FIG. 5 with the slot identifier 3, the sorting circuit 302 selects the free slot 516 and obtains a new page virtual address 520 for an available memory page (bucket) 540 from the queue 536 if one is available. If a new page virtual address 520 is not available from the queue 536, the sorting circuit 302 sends an export request failure response 538 to the producer compute unit 222 and the compute unit 222 then performs one or more fallback procedures, as described above. If a new page virtual address 520 is available from the queue 536, the sorting circuit 302 populates the selected slot 516 with the new page virtual address 520 and the key 504-1 included in the payload export request 502, thereby forming a key/slot pair mapped to the new page virtual address 520. The sorting circuit 302 then sends an export request success response 528 to the producer unit 222 that includes a payload virtual address 530, a slot identifier 518, and a granted payload count 532, as described above. The producer compute unit 222 then proceeds to write one or more payloads 232 to the page virtual address 530, as described above.

In some instances, there may be no free slots 516 in the sorting data structure 514 but there is at least one unblocked slot 516 (e.g., slots 0, 1, and 2 in FIG. 5), such as a slot 516 mapped to an unblocked key 504-2. In at least some implementations when this situation is encountered, the sorting circuit 302 determines if any of the unblocked slots 516 have a reserve count 522 equal to their done count 524, which indicates that all export requests that have been received for that slot 516 have completed. If none of the unblocked slots 516 have a reserve count 522 equal to their done count 524, the sorting circuit 302 sends an export request failure response 538 to the producer compute unit 222 and the compute unit 222 then performs one or more fallback procedures, as described above.

If at least one of the unblocked slots 516 has a reserve count 522 equal to their done count 524 and there is an available page virtual address 520 in the queue 536, the sorting circuit 302 selects and clears one of these unblocked slots 516 and evicts the memory page 540 associated with the slot 516, as described above. If multiple unblocked slots 516 have a reserve count 522 equal to their done count 524, the sorting circuit 302 selects the unblocked slot 516 with the highest done count 524, randomly selects an unblocked slot 516, or uses any other selection technique for selecting one of the unblocked slots 516. The sorting circuit 302 populates the selected slot 516 with the new page virtual address 520 and the key 504-1 included in the payload export request 502 received from the producer compute unit 222, thereby forming a key/slot pair mapped to the new page virtual address 520. The sorting circuit 302 then sends an export request success response 528 to the consumer unit 222, as described above. The sorting circuit 302 also sends a scheduling message 534 to one or more scheduling mechanisms of the scheduling domain 224. In this example, the scheduling message 534 includes the key 504 associated with the memory page 540 being evicted, the virtual address 520 of the memory page 540, and the done count 524 associated with the memory page 540. In response to receiving the scheduling message 534, the scheduling mechanism proceeds to schedule the payloads 232 stored at the evicted memory page 238, as described above.

In at least some implementations, instead of performing the page eviction and other operations described above, the sorting circuit 302 is configured to only manage the sorting data structure 514 for performing conflict resolution (e.g., make every payload export request appear atomic). In other implementations, instead of the scheduling mechanism of the scheduling domain 224 performing memory page management, sorting circuit 302 is configured to perform the memory page management. In these implementations, the sorting circuit 302 utilizes one or more interfaces to explicitly free pages from a compute unit 222, such as a shader core. The sorting circuit 302 also implements logic to select the next free page from its own managed pool or memory pages, which is initially set up with a single address, page size, a page count by firmware). In at least some implementations, instead of managing with same-sized or fixed-sized pages, the sorting circuit 302 performs advanced memory suballocation to select a page size that reduces the static memory overhead imposed by same-size pages. For example, the sorting circuit 302 selects an appropriately sized page solely depending on the provided maximum payload count 510 and payload size/stride.

FIG. 7 to FIG. 10 are diagrams together illustrating an example method 700 of a sorting circuit in a scheduling domain performing compute unit independent sorting of payloads in accordance with at least some implementations. It should be understood that the processes described below with respect to method 700 have been described above in greater detail with reference to FIG. 1 to FIG. 6. For purposes of description, the method 700 is described with respect to an example implementation at the computing system 200 of FIG. 2, but it will be appreciated that, in other implementations, the method 700 is implemented at processing devices having different configurations. Also, the method 700 is not limited to the sequence of operations shown in FIG. 7 to FIG. 10, as at least some of the operations can be performed in parallel or in a different sequence. Moreover, in at least some implementations, the method 700 can include one or more different operations than those shown in FIG. 7 to FIG. 10.

At block 702, the sorting circuit 302 receives a payload export request 502 from a producer compute unit 222. As described above, the payload export request 502, in at least some implementations, includes parameters such as a key 504-1, PL size 506, PL count 508, and a maximum PL count 510. At block 704, the sorting circuit 302 searches a sorting data structure 514, such as table or map, for a slot 516 having a key 504-2 matching the key 504-1 received in the payload export request 502. At block 706, the sorting circuit 302 determines if a matching key 504-2 was found. If a matching key 504-2 was not found, this indicates that none of the memory pages (buckets) 540 associated with the slots 516 of the sorting data structure 514 are available for sorting the payload(s) 232 requested to be exported by the producer compute unit 222, and the method 700 proceeds to block 734 of FIG. 9.

At block 708, if a matching key 504-2 was found, the sorting circuit 302 increments the reserve count 522 of the identified slot 516. At block 710, the sorting circuit 302 determines if the reserve count 522 is equal to the maximum payload count 510 set for the memory page(s) 540 associated with the identified slot 516. If the reserve count 522 is not equal to the maximum payload count 510, the method proceeds to block 714. At block 712, if the reserve count 522 is equal to the maximum payload count 510, the sorting circuit 302 blocks the key 504-2 associated with the identified slot 516 so that other compute units 222 are not able to write to the memory page(s) 540. At block 714, the sorting circuit 302 generates an export request success response 528. As described above, the export request success response 528 includes, for example, a payload virtual address 530, the slot identifier 518, and granted payload count 532. At block 716, the sorting circuit 302 sends the export request success response 528 to the producer compute unit 222, and the method 700 proceeds to block 718 of FIG. 8.

At block 718, the producer compute unit 222 writes one or more payloads 232 to the memory page(s) 540 associated with the payload virtual address 530 included in the export request success response 528. At block 720, the sorting circuit 302 receives an export done message 526 from the producer compute unit 222, which signals the sorting circuit 302 that the producer compute unit 222 has completed its export process such that all payloads 232 have been written to the memory page(s) 540. At block 722, the sorting circuit 302 increments the done count 524 for the slot 516 associated with the export done message 526. At block 724, the sorting circuit 302, determines if the done count 524 is equal to the maximum payload count 510 associated with the slot 516. If the done count 524 is not equal to the maximum payload count 510, the sorting circuit 302 determines additional payloads 232 can be written to the memory page 540 associated with the slot 516 and the method returns to block 702. Then, if a second payload export request 502 is received that includes the same key 504 as provided in the request 502 received at block 702, the sorting circuit 302, in at least some implementations, sorts the second payload export request 502 into the same memory page (bucket) 540 based on the operations described above.

At block 726, if the done count 524 is equal to the maximum payload count 510, additional payloads 232 cannot be written to the memory page 540 and the sorting circuit 302 clears/frees the slot 516 associated with the export done message 526. As described above, clearing the slot 516 includes, for example, setting the page virtual address 520 to null and resetting the reserve count 522 and done count 524 for the slot 516. At block 728, the sorting circuit 302 evicts the memory page 540 associated with the cleared slot 516 by, for example, sending a scheduling message 534 to one or more scheduling mechanisms, such as a local scheduler circuit 230 of the scheduling domain 224. As described above, the scheduling message 534 includes, for example, the key 504 associated with the evicted memory page 540, the virtual address 520 of the evicted memory page 540, and the done count 524 associated with the evicted memory page 540. At block 730, the local scheduler circuit 230 schedules the payloads 232 stored in the evicted memory page 540 for execution by one or more consumer compute units 222. At block 732, the consumer compute unit(s) 222 executes the one or more payloads 232. The method then returns to block 702.

As described above with respect to FIG. 7, when a payload export request 502 is received from a producer compute unit 222, the sorting circuit 302 searches the sorting data structure 514 for a slot 516 having a key 504-2 matching the key 504-1 received in the payload export request 502. If a matching key 504-2 is not found, the method 700 proceeds to block 734 of FIG. 9. At block 734, the sorting circuit 302 determines if there is at least one free slot 516 or unblocked slot 516, and a new page virtual address 520 in the page virtual address queue 536. At block 736, if there are no free slots 516 or unblocked slots 516 or if there is no new page virtual addresses 520 available, the sorting circuit 302 sends an export request failure response 538 to the producer compute unit 222. The producer compute unit 222 then performs one or more fallback procedures. The method 700 then returns to block 702.

At block 738, the sorting circuit 302 determines if the available slot 516 is a free slot 516. If the available slot is not a free slot 516, but is an unblocked slot 516, the method 700 proceeds to block 742 of FIG. 10. Otherwise, at block 740, the sorting circuit 302 selects one of the free slots 516, and the method 700 returns to block 708 of FIG. 7. Referring now to FIG. 10, at block 742, the sorting circuit 302 determines if any of the unblocked slots 516 have a reserve count 522 equal to their done count 524, which indicates that all export requests that have been received for that slot 516 have completed. At block 744, if none of the unblocked slots 516 have a reserve count 522 equal to their done count 524, the sorting circuit 302 sends an export request failure response 538 to the producer compute unit 222. The producer compute unit 222 then performs one or more fallback procedures. The method 700 then returns to block 702.

At block 746, if at least one of the unblocked slots 516 has a reserve count 522 equal to its done count 524, the sorting circuit 302 selects this unblocked slot 516 and clears/frees the slot 516. At block 748, the sorting circuit evicts the memory page 540 associated with the cleared slot 516 by, for example, sending a scheduling message 534 to one or more scheduling mechanisms, such as a local scheduler circuit 230 of the scheduling domain 224. At block 750, the local scheduler circuit 230 schedules the payloads 232 stored in the evicted memory page 540 for execution by one or more consumer compute units 222. At block 752, the consumer compute unit(s) 222 executes the one or more payloads 232. The method then returns to block 702.

One or more of the elements described above is circuitry designed and configured to perform the corresponding operations described above. Such circuitry, in at least some implementations, is any one of, or a combination of, a hardcoded circuit (e.g., a corresponding portion of an application-specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components”, “units”, “devices”, “circuitry”, etc.) are described or claimed as “configured” to perform one or more tasks or operations. This formulation of [entity] configured to [perform one or more tasks] is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to”. An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some implementations, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method, comprising:
responsive to receiving a request from a computing unit of a processor to export a payload, determining, by the processor, whether a bucket for sorting the payload is available based on a first key included in the request; and
responsive to determining a bucket is available, sending, by the processor, a response to the compute unit comprising an indication of the bucket.

2. The method of claim 1, wherein the indication comprises a virtual address associated with the bucket at which the compute unit is to write the payload.

3. The method of claim 1, wherein the indication prompts the compute unit to store the payload in the bucket.

4. The method of claim 1, further comprising:
receiving, by the processor, a notification from the compute unit indicating the compute unit has completed storing the payload in the bucket.

5. The method of claim 4, further comprising:
responsive to receiving the notification from the compute unit, determining, by the processor, the bucket is full; and
responsive to determining the bucket is full, notifying, by the processor, a scheduler circuit of the processor that payloads in the bucket are ready for scheduling.

6. The method of claim 5, further comprising:
scheduling, by the scheduler circuit, the payloads for execution by one or more of compute units of a processing element of the processor.

7. The method of claim 5, wherein notifying the scheduler circuit comprises:
notifying a local scheduler circuit coupled to a plurality of processing elements of the processor.

8. The method of claim 5, wherein notifying the scheduler circuit comprises:
notifying at least one local scheduler circuit of a plurality of local scheduler circuits each coupled to a different processing element of the processor.

9. The method of claim 1, wherein determining if a bucket is available comprises:
searching, by the processor, a data structure mapping key-slot pairs to a plurality of buckets; and
responsive to searching the data structure, determining, by the processor, a bucket of the plurality of buckets is available based on a slot in the data structure comprising a second key matching the first key; or
responsive to searching the data structure, determining, by the processor, the plurality of buckets is unavailable based on each slot in the data structure failing to be associated with a second key matching the first key.

10. The method of claim 9, further comprising:
responsive to determining the plurality of buckets is unavailable, selecting a slot from the data structure currently unmapped to a bucket; and
associating the selected slot with a second key matching the first key and further associating the selected slot with a virtual address associated with an available bucket,
wherein sending the response to the compute unit is in response associating the selected slot with the second key and the virtual address.

11. The method of claim 9, further comprising:
responsive to determining the plurality of buckets is unavailable, selecting a slot from the data structure currently mapped to a bucket of the plurality of buckets;
clearing, by the processor, the selected slot;
notifying, by the processor, a scheduler circuit of the processor that payloads in the bucket are ready for scheduling; and
associating the selected slot with a second key matching the first key and further associating the selected slot with a virtual address associated with an available bucket,
wherein sending the response to the compute unit is in response associating the selected slot with the second key and the virtual address.

12. A processor, comprising:
a plurality of processing elements each comprising one or more compute units; and
a sorting circuit configured to:
responsive to a request received from a compute unit of the one or more compute units to export a payload, determine if a bucket for sorting the payload is available based on a first key included in the request; and
responsive to a bucket being available, send a response to the compute unit comprising an indication of the bucket.

13. The processor of claim 12, wherein the indication comprises a virtual address associated with the bucket at which the compute unit is to write the payload.

14. The processor of claim 12, wherein the at least one sorting circuit is further configured to:
responsive to a notification received from the compute unit indicating the compute unit completed storing the payload in the bucket, determine, the bucket is full; and
responsive to the bucket being full, notify a scheduler circuit of the processor that payloads in the bucket are ready for scheduling.

15. The processor of claim 14, wherein the scheduler circuit is configured to:
schedule the payloads for execution by at least one of the one or more compute units.

16. The processor of claim 14, wherein the scheduler circuit is one of a local scheduler circuit coupled to the plurality of processing elements or a local scheduler circuit of a plurality of local scheduler circuits each coupled to a different processing element of the plurality of processing elements.

17. The processor of claim 12, wherein the sorting circuit is configured to determine if a bucket is available by:
searching a data structure mapping key-slot pairs to a plurality of buckets; and
responsive to searching the data structure, determining a bucket of the plurality of buckets is available based on a slot in the data structure comprising a second key matching the first key; or
responsive to searching the data structure, determining the plurality of buckets is unavailable based on each slot in the data structure failing to be associated with a second key matching the first key.

18. The processor of claim 17, further wherein the sorting circuit is further configured to:
responsive to the plurality of buckets being unavailable, select a slot from the data structure currently unmapped to a bucket; and
associate the selected slot with a second key matching the first key and further associate the selected slot with a virtual address associated with an available bucket,
wherein the sorting circuit is configured to send the response to the compute unit in response to associating the selected slot with the second key and the virtual address.

19. The processor of claim 17, wherein the sorting circuit is further configured to:
responsive to the plurality of buckets being unavailable, select a slot from the data structure currently mapped to a bucket of the plurality of buckets;
clear the selected slot;
notify a scheduler circuit of the processor that payloads in the bucket are ready for scheduling; and
associate the selected slot with a second key matching the first key and further associate the selected slot with a virtual address associated with an available bucket,
wherein the sorting circuit is configured to send the response to the compute unit in response to associating the selected slot with the second key and the virtual address.

20. A system, comprising:
a processor;
memory;
a plurality of scheduling domains, each scheduling domain of the plurality of scheduling domains comprising at least one local scheduler circuit and one or more workgroup processing elements comprising a plurality of compute units; and
a sorting circuit configured to:
responsive to a request received from a compute unit of the plurality of compute units to export a payload, determine if a bucket for sorting the payload is available based on a first key included in the request; and
responsive to a bucket being available, send a response to the compute unit comprising an indication of the bucket.
